(19) United States
(12) Patent Application Publication
(10) Pub. No.: US 2022/0196155 A1
(43) Pub. Date: Jun. 23, 2022

(54) FUEL TANK ISOLATION VALVE FOR VEHICLE

(71) Applicant: HYUNDAI KEFICO CORPORATION, Gunpo (KR)

(72) Inventors: Du Seok Lee, Gwangmyeong (KR); Ahn Hee Lee, Dongjak-gu (KR); Kyung Hwan Kim, Gunpo (KR)

(21) Appl. No.: 17/556,566

(22) Filed: Dec. 20, 2021

(30) Foreign Application Priority Data
Dec. 21, 2020 (KR) 10-2020-0179210

(51) Int. Cl. F16K 1/54; F16K 1/44; B60K 15/03

(52) U.S. Cl. CPC F16K 1/54; B60K 2015/03256; B60K 15/03; F16K 1/443

(57) ABSTRACT

A fuel tank isolation valve for a vehicle includes a drive unit having a solenoid coil; a flow path unit having a vaporized fuel gas flow path; a valve assembly configured to open or close the flow path in the flow path unit by being operated by the drive unit, where the valve assembly includes: a first valve configured to open the flow path by being operated by a magnetic force generated by the coil; and a second valve configured to open the flow path while operating in conjunction with the first valve by being caught by the first valve when the first valve operates. The first valve and the second valve may operate in conjunction with each other by being mechanically caught, such that it is not necessary to provide a separate spring for operating the second valve.

### CROSS-REFERENCE TO RELATED APPLICATION(S)

This application claims under 35 U.S.C. § 119 the benefit of Korean Patent Application No. 10-2020-0179210 filed on Dec. 21, 2020, the entire contents of which are incorporated herein by reference.

### BACKGROUND

### (a) Technical Field

The present disclosure relates to a fuel tank isolation valve for a vehicle, more particularly, to the fuel tank isolation valve that is installed between a fuel tank and a canister, and which is configured to control a flow of vaporized fuel gas.

### (b) Description of the Related Art

Because vehicle exhaust gas contributes to air pollution, regulations on the vehicle exhaust gas have become gradually stricter. A vaporized fuel gas, which is generated from a fuel tank as one of a plurality of vehicle exhaust gases, is also prevented from being discharged directly into the atmosphere.

Therefore, the vaporized fuel gas is stored in a canister embedded with activated carbon and adsorbed by the activated carbon. Thereafter, the vaporized fuel gas is supplied into a combustion chamber of an engine and combusted.

A fuel tank isolation valve (FTIV) is installed in a vaporized fuel gas discharge pipe between the fuel tank and the canister.

The fuel tank isolation valve refers to a solenoid type electromagnetic control valve that is opened or closed by being controlled by an electronic control unit, which receives a fuel tank internal pressure value from a fuel tank pressure sensor, so that a fuel tank internal pressure is maintained at a predetermined level.

As illustrated in FIG. 1 (RELATED ART), the fuel tank isolation valve has a valve assembly configured to open or close flow paths (an inflow path 1a and an outflow path 1b) of a housing 1. The valve assembly has two parts and thus may open the flow paths in a two-step manner.

The valve assembly includes a first valve 3 and a second valve 5. The first valve 3 is pressed by a first spring 4 and blocks a flow path hole formed in the second valve 5. The second valve 5 is pushed by the first valve 3 and blocks an entire inlet of an outflow path 1b.

When a solenoid is turned on in this state, the first valve 3 moves upward while compressing the first spring 4, such that the flow path hole of the second valve 5 is opened (step 1). Further, the second valve 5 is moved upward by a second spring 6 that supports the second valve 5 upward, such that the entire outflow path 1b is opened (step 2).

Since the fuel tank isolation valve in the related art uses the springs to operate the two valves as described above, there is a problem in that there is a large number of components is increased, and an internal structure of a housing for installing the springs is complicated, which results in excess costs and a large number of processes required to manufacture the fuel tank isolation valve.

### SUMMARY

The present disclosure provides a fuel tank isolation valve for a vehicle, which may perform a two-step opening operation using a single spring, thereby reducing the number of components and simplifying an internal structure of a housing.

In particular, the present disclosure provides a fuel tank isolation valve for a vehicle, the fuel tank isolation valve including: a drive unit having a solenoid coil; a flow path unit having a vaporized fuel gas flow path; a valve assembly configured to open or close the flow path in the flow path unit by being operated by the drive unit, in which the valve assembly includes: a first valve configured to open the flow path by being operated by a magnetic force generated by the coil; and a second valve configured to open the flow path while operating in conjunction with the first valve by being caught by the first valve when the first valve operates.

The first valve may include an upper body and a lower body, a coupling groove may be formed between the upper body and the lower body so as to be concave inward in a radial direction, an inner end of an upper plate of the second valve may be inserted into the coupling groove, and the upper plate may be caught by an upper surface of the lower body when the first valve moves upward, such that the second valve moves upward in conjunction with the first valve.

An opening portion may be formed in the upper plate of the second valve by removing a partial area of the upper plate in a circumferential direction, and the first valve may be inserted into and assembled with the second valve through the opening portion.

The second valve may include: the upper plate; a lower plate; a connection part configured to connect the upper plate and the lower plate; and a seal member coupled to an inner end of the lower plate, a plurality of through-holes may be formed in the connection part, and a flow path hole may be formed in the seal member.

The seal member of the second valve may open or close an inlet of an outflow path of the flow path unit, and the lower body of the first valve may open or close the flow path hole of the seal member.

The upper body of the first valve may be inserted into a lower guide hole formed in a core of the drive unit such that an operation route is guided, and a spring configured to continuously push the first valve downward may be installed in the lower guide hole.

A guide rod may be formed on the upper body of the first valve, an upper guide hole may be formed in the lower guide hole of the core, and the guide rod may be inserted into the upper guide hole such that the operation route is guided.

The flow path unit may include: an inflow path into which the vaporized fuel gas is introduced; an outflow path from which the vaporized fuel gas is discharged; and a valve chamber formed between the inflow path and the outflow path, and the valve assembly may be installed in the valve chamber.

The flow path unit may further include another valve chamber connected to the inflow path and the outflow path, and a relief valve configured to operate by a difference in pressure between the inflow path and the outflow path may be installed in the valve chamber.

According to the present disclosure, since the first valve and the second valve operate in conjunction with each other by means of the catching projection structure, it is not necessary to use a spring to operate the second valve.

Since it is not necessary to use two springs to operate the first valve and the second valve, the number of components is reduced.

In addition, because it is not necessary to form a seating portion shape in the housing to install a spring for operating the second valve, the internal structure of the housing is simplified.

Accordingly, the costs and the number of processes required to manufacture the fuel tank isolation valve may be reduced.

### BRIEF DESCRIPTION OF THE DRAWINGS

FIG. 1 (RELATED ART) is a cross-sectional view illustrating a structure in which a valve assembly of a fuel tank isolation valve in the related art is installed.

FIG. 2 is a cross-sectional front view of a fuel tank isolation valve according to the present disclosure.

FIG. 3 is a perspective view of a valve assembly that is a main component of the present disclosure.

FIG. 4 is a view illustrating a state of operation of the fuel tank isolation valve in which the valve assembly does not operate when power is turned off.

FIG. 5 is a view illustrating a state of operation of the fuel tank isolation valve in which only a first valve is opened when power is initially turned on.

FIG. 6 is a view illustrating a state of operation of the fuel tank isolation valve in which a second valve is opened in conjunction with the first valve.

FIG. 7 is a view illustrating a state in which the valve assembly is maximally opened.

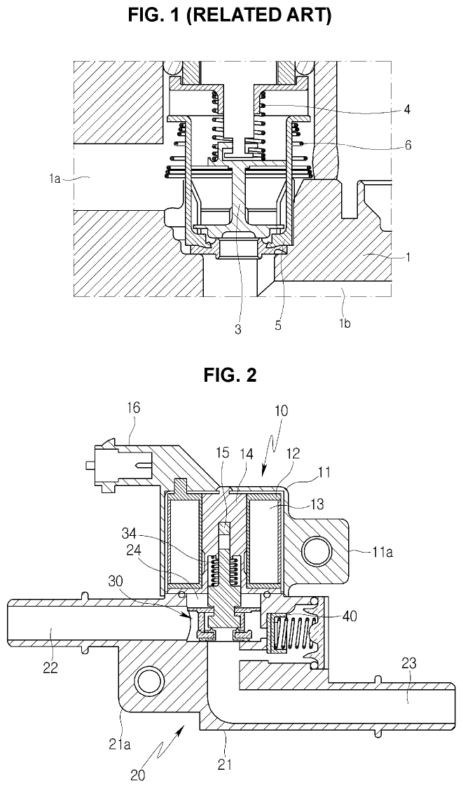

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

The present disclosure may be variously modified and may have various embodiments, and particular embodiments illustrated in the drawings will be described in detail below. However, the description of the exemplary embodiments is not intended to limit the present disclosure to the particular exemplary embodiments, but it should be understood that the present disclosure is to cover all modifications, equivalents and alternatives falling within the spirit and technical scope of the present disclosure. Thicknesses of lines illustrated in the accompanying drawings, sizes of constituent elements, or the like may be exaggerated for clarity and convenience of description.

In addition, the terms used below are defined in consideration of the functions in the present disclosure and may vary depending on the intention of a user or an operator or precedents. Therefore, the definition of the terms should be made based on the entire contents of the present specification.

Hereinafter, exemplary embodiments according to the present disclosure will be described in detail with reference to the accompanying drawings.

As illustrated in FIG. 2, a fuel tank isolation valve for a vehicle according to the present disclosure includes a solenoid type drive unit 10, a flow path unit 20 having a vaporized fuel gas flow path, and a valve assembly 30 configured to open or close a flow path in the flow path unit 20 by being operated by the drive unit 10.

The drive unit 10 has a solenoid coil 13 (hereinafter, referred to as a ‘coil’) disposed in a cylindrical housing 11. The coil 13 is wound around an outer periphery of a cylindrical bobbin 12, and a core 14, which is a magnetic element, is inserted into an inner hole of the bobbin 12.

When electric current is supplied to the coil 13, a magnetic field is formed, and the magnetic field is further intensified by the core 14. The valve assembly 30 is operated by the magnetic force generated as described above.

The housing 11 has a mount part 11a having a bolt hole so that the fuel tank isolation valve may be mounted on a fixing part of a vehicle.

In addition, a connector 16 is integrally formed at one side of the housing 11. A power source connector is connected to the connector 16, such that power is supplied to the coil 13 through an inner conductive wire.

A housing 21 of the flow path unit 20 is connected to a lower portion of the housing 11 of the drive unit 10. In the housing 21 of the flow path unit 20, an inflow path 22 connected to a fuel tank is formed, and an outflow path 23 connected to a canister is formed. The inflow path 22 and the outflow path 23 are connected to a valve chamber 24 formed at a center of the housing. The valve chamber 24 is opened at an upper side thereof. The valve chamber 24 is sealed from the outside as the housing 11 of the drive unit 10 and the housing 21 of the flow path unit 20 are coupled to each other. The valve assembly 30 is installed in the valve chamber 24.

Another valve chamber is formed in the housing 21 of the flow path unit 20 and connected to the valve chamber 24 and the outflow path 23, and a relief valve 40 is installed in the valve chamber. The relief valve 40 is opened by a difference in pressure between the inflow path 22 and the outflow path 23 and moves vaporized fuel gas to the canister. Therefore, the pressure in the fuel tank may be maintained at a predetermined level.

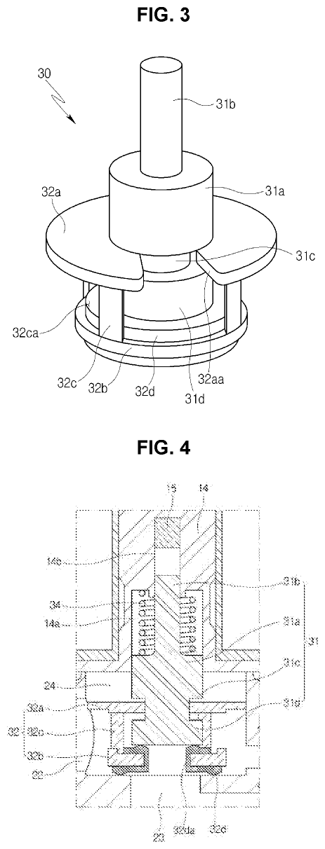

As illustrated in FIGS. 3 and 4, the valve assembly 30 includes a first valve 31 and a second valve 32.

The first valve 31 is a magnetic element which is pulled toward the core 14 by a magnetic force generated by the electric current applied to the coil 13. The first valve 31 is typically called an armature.

The first valve 31 includes a cylindrical upper body 31a, a guide rod 31b protruding upward from a center of an upper surface of the upper body 31a and having a circular cross-section, a coupling groove 31c provided at a lower portion of the upper body 31a, formed to be concave inward, and having a reduced diameter, and a lower body 31d provided at a lower portion of the coupling groove 31c and having a circular plate shape having the same diameter as the upper body 31a.

The coupling groove 31c is formed between the upper body 31a and the lower body 31d. The coupling groove 31c is formed along an entire periphery of the first valve 31 and has a constant width and a constant depth.

The second valve 32 is made of a non-magnetic plastic material. The second valve 32 includes an upper plate 32a having a circular plate shape, a lower plate 32b having a circular plate shape and having a smaller diameter than the upper plate 32a, a cylindrical connection part 32c configured to connect the upper plate 32a and the lower plate 32b, and a seal member 32d provided on the lower plate 32b. Circular through-holes are respectively formed at a center of the upper plate 32 and a center of the lower plate 32b.

The diameter of the upper plate 32a is smaller than the diameter of the valve chamber 24, such that the second valve 32 may move upward or downward in the valve chamber 24. A gap between the valve chamber 24 and the upper plate 32a is small, such that the operation of the second valve 32 may be guided by an inner peripheral surface of the valve chamber 24.

The upper plate 32a has an opening portion 32aa formed by partially removing a predetermined area of the upper plate 32a in a circumferential direction, and the through-hole in the upper plate 32a is exposed to the outside through the opening portion 32aa. A part of the coupling groove 31c of the first valve 31 is inserted into the second valve 32 through the opening portion 32aa, such that the first valve 31 and the second valve 32 may be easily assembled.

The connection part 32c has a plurality of through-holes 32ca formed in a circumferential direction thereof. The through-hole 32ca has an approximately rectangular shape, and the vaporized fuel gas is introduced into the second valve 32 through the through-hole 32ca.

The seal member 32d is made of a material such as rubber having elasticity and has an approximately thin circular plate shape. An inner end of the lower plate 32b is inserted into a coupling groove formed in a middle portion in a thickness direction of the seal member 32d, such that the seal member 32d is assembled with the lower plate 32b.

The seal member 32d has a flow path hole 32da that penetrates a central portion of the seal member 32d. The flow path hole 32da has a smaller diameter than the lower body 31d of the first valve 31, such that the flow path hole 32da may be blocked by the lower body 31d. In addition, the diameter of the seal member 32d is larger than a diameter of an inlet portion of the outflow path 23, such that the seal member 32d may block the outflow path 23.

The first valve 31 and the second valve 32 are assembled through the opening portion 32aa. The first valve 31 is inserted into the second valve 32 through the opening portion 32aa of the upper plate 32a. In the state in which the first valve 31 is inserted into the second valve 32, an inner end (inner peripheral surface) of the upper plate 32a of the second valve 32 is inserted into the coupling groove 31c of the first valve 31 and caught in an upward/downward direction. Further, the lower body 31d of the first valve 31 may move in the upward/downward direction between the seal member 32d and the upper plate 32a of the second valve 32.

The assembled valve assembly 30 is installed in the valve chamber 24 as described above, and the core 14 of the drive unit 10 is positioned at an upper side of the valve chamber 24.

The core 14 has a lower guide hole 14a having a finely larger diameter than the upper body 31a of the first valve 31. An upper guide hole 14b having a finely larger diameter than the guide rod 31b of the first valve 31 is formed at an upper side of the lower guide hole 14a.

The guide holes 14a and 14b serve to guide the upward and downward operations of the first valve 31. The upper body 31a is inserted into the lower guide hole 14a, and the guide rod 31b is inserted into the upper guide hole 14b, such that the upward and downward movements of the first valve 31 are guided.

In addition, a stopper 15 is inserted in advance into the upper guide hole 14b to restrict an upward movement position of the guide rod 31b, such that an upward movement position of the valve assembly 30 is restricted to a predetermined position.

In addition, a spring 34 is installed in the lower guide hole 14a. Two opposite ends of the spring 34 are supported on an upper surface of the lower guide hole 14a and an upper surface of the upper body 31a, such that the spring 34 continuously applies a force for pushing the upper body 31a, i.e., the first valve 31 downward to restore the first valve 31.

An operation and operational effect of the present disclosure will be described below.

FIG. 4 illustrates a state of the valve assembly 30 when the solenoid is turned off. The seal member 32d of the second valve 32 is in close contact with the inlet of the outflow path 23. The lower body 31d of the first valve 31 is in close contact with an upper surface of the seal member 32d, i.e., the inlet of the flow path hole 32da. The restoring force of the spring 34 is applied downward, such that the positions of the first and second valves 31 and 32 are stably maintained. Therefore, the inflow path 22 and the outflow path 23 are completely blocked, such that the vaporized fuel gas cannot move.

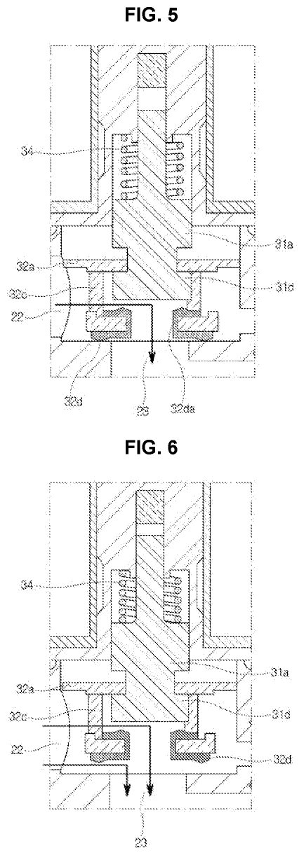

FIG. 5 illustrates a state immediately after the solenoid is turned on. When the magnetic force is generated as the electric current is supplied to the coil 13, the first valve 31 moves upward while compressing the spring 34. Therefore, the lower body 31d of the first valve 31 moves away from the seal member 32d, and the flow path hole 32da of the seal member 32d is opened, such that the first-step opening of the flow path is performed.

In this case, the vaporized fuel gas is introduced into the second valve 32 through the through-hole 32ca formed at the lateral side of the second valve 32 and then discharged to the outflow path 23 through the flow path hole 32da of the seal member 32d.

When the first valve 31 is further moved upward by the magnetic force, the inner end of the upper plate 32a of the second valve 32 is caught by the upper surface of the lower body 31d of the first valve 31, such that the second valve 32 moves upward together with the first valve 31, as illustrated in FIG. 6. Therefore, the seal member 32d of the second valve 32 moves away from the inlet of the outflow path 23, such that the second-step opening is performed in which the entire outflow path 23 is opened.

In this case, the vaporized fuel gas is discharged directly to the outflow path 23 from the inflow path 22 through a discharge route without passing through the inside of the second valve 32 except for the discharge route described with reference to FIG. 5.

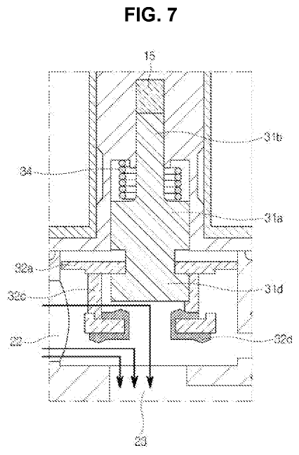

FIG. 7 illustrates a state in which the solenoid is kept turned on and the first valve 31 is moved maximally upward by the magnetic force, i.e., the guide rod 31b comes into contact with the stopper 15. The second valve 32 is also maximally moved upward in conjunction with the first valve 31.

Therefore, the largest cross-sectional area of the flow path connecting the inflow path 22 and the outflow path 23 is ensured, such that the movement amount of the fuel exhaust gas is maximized.

Meanwhile, when the supply of power is cut off, the magnetic force is not generated any further by the coil 13 and the core 14, and only the restoring force of the spring 34 is applied, such that the valve assembly 30 moves downward and returns to the original position. That is, the states illustrated in FIGS. 4 to 7 are restored in the reverse order, such that the seal member 32d comes into close contact with the inlet of the outflow path 23. Thereafter, the lower body 31d of the first valve 31 comes into close contact with the upper surface of the seal member 32d, such that the vaporized fuel gas discharge passageway is sequentially blocked.

As described above, the fuel tank isolation valve according to the present disclosure has the two valves, like the related art, and thus may open the vaporized fuel gas outflow path in a two-step manner. In this case, the second valve 32 opens the flow path while moving upward in conjunction with the first valve 31 by means of the catching projection structure.

Therefore, unlike the related art, the fuel tank isolation valve according to the present disclosure need not use a separate spring to open the second valve, which makes it possible to reduce the number of components.

In addition, it is not necessary to provide a support surface for stably installing a spring for the second valve in the housing, which makes it possible to simplify the internal structure of the housing.

As a result, the number of components is reduced, and the structure is simplified, which makes it possible to reduce manufacturing costs and the number of processes.

Meanwhile, a stroke of the second valve 32 varies depending on a height of the upper surface (catching projection) of the lower body 31d of the first valve 31. That is, when an overall length of the first valve 31 in the upward/downward direction remains the same, the stroke of the second valve 32 increases as the thickness of the lower body 31 increases, and the stroke of the second valve 32 decreases as the thickness of the lower body 31 decreases.

Therefore, the value of the stroke of the second valve 32 may be easily adjusted by adjusting the thickness of the lower body 31d, such that the flow rate of the valve may be easily adjusted.

While the present disclosure has been described above with reference to the exemplary embodiment depicted in the drawings, the exemplary embodiment is described just for illustration, and those skilled in the art will understand that various modifications of the exemplary embodiment and any other exemplary embodiment equivalent thereto are available. Accordingly, the true technical protection scope of the present disclosure should be determined by the appended claims.

What is claimed is:

1. A fuel tank isolation valve for a vehicle, the fuel tank isolation valve comprising:
a drive unit having a solenoid coil;
a flow path unit having a vaporized fuel gas flow path;
a valve assembly configured to open or close the flow path in the flow path unit by being operated by the drive unit,
wherein the valve assembly comprises:
a first valve configured to open the flow path by being operated by a magnetic force generated by the coil; and
a second valve configured to open the flow path while operating in conjunction with the first valve by being caught by the first valve when the first valve operates.

2. The fuel tank isolation valve of claim 1, wherein the first valve comprises an upper body and a lower body, a coupling groove is formed between the upper body and the lower body so as to be concave inward in a radial direction, an inner end of an upper plate of the second valve is inserted into the coupling groove, and the upper plate is configured to be caught by an upper surface of the lower body when the first valve moves upward, such that the second valve moves upward in conjunction with the first valve.

3. The fuel tank isolation valve of claim 2, wherein an opening portion is formed in the upper plate of the second valve by removing a partial area of the upper plate in a circumferential direction, and the first valve is inserted into and assembled with the second valve through the opening portion.

4. The fuel tank isolation valve of claim 2, wherein the second valve comprises:
the upper plate;
a lower plate;
a connection part configured to connect the upper plate and the lower plate; and
a seal member coupled to the lower plate,
wherein a plurality of through-holes is formed in the connection part, and a flow path hole is formed in the seal member.

5. The fuel tank isolation valve of claim 4, wherein the seal member of the second valve is configured to open or close an inlet of an outflow path of the flow path unit, and the lower body of the first valve is configured to open or close the flow path hole of the seal member.

6. The fuel tank isolation valve of claim 2, wherein the upper body of the first valve is inserted into a lower guide hole formed in a core of the drive unit such that an operation route is guided, and
wherein a spring configured to continuously push the first valve downward is installed in the lower guide hole.

7. The fuel tank isolation valve of claim 6, wherein a guide rod is formed on the upper body of the first valve, an upper guide hole is formed in the lower guide hole of the core, and the guide rod is inserted into the upper guide hole such that the operation route is guided.

8. The fuel tank isolation valve of claim 1, wherein the flow path unit comprises:
an inflow path into which the vaporized fuel gas is introduced;
an outflow path from which the vaporized fuel gas is discharged; and
a valve chamber formed between the inflow path and the outflow path,
wherein the valve assembly is installed in the valve chamber.

9. The fuel tank isolation valve of claim 8, wherein the flow path unit further comprises another valve chamber connected to the inflow path and the outflow path, and a relief valve configured to operate by a difference in pressure between the inflow path and the outflow path is installed in the valve chamber.
